(19) United States
(12) Patent Application Publication
(10) Pub. No.: US 2015/0159549 A1
(43) Pub. Date: Jun. 11, 2015

(54) ENGINE BLOCK FOR INTERNAL COMBUSTION ENGINE

(71) Applicant: ELECTRO-MOTIVE DIESEL, INC., La Grange, IL (US)

(72) Inventors: Abhinav R. Pamulaparthy, Aurora, IL (US); Jeffrey P. Nowak, Munster, IN (US)

(73) Assignee: ELECTRO-MOTIVE DIESEL, INC., La Grange, IL (US)

(21) Appl. No.: 14/623,661

(22) Filed: Feb. 17, 2015

(51) Int. Cl. F02B 67/00; F02F 7/00

(52) U.S. Cl. CPC F02B 67/00; F02F 7/0068

(57) ABSTRACT

An engine block with a first end and a second end is provided. The first end defines a first periphery portion, at least one conduit disposed proximal to a camshaft mounting portion, and a first attachment portion that extends from the first periphery portion to mount a gear assembly. Further, the second end defines a second periphery portion. The second periphery portion includes a second attachment portion located proximal to the second periphery portion that defines a mounting surface for an electrical accessory, a third attachment portion structured to mount a speed sensor unit. A side includes a fourth attachment portion and at least one support pad. The fourth attachment portion is disposed proximal to the first end of the block to mount an oil separator. The at least one support pad is disposed proximal to the first end to mount an engine aftertreatment system.

### TECHNICAL FIELD

The present disclosure relates to engine blocks. More particularly, the present disclosure relates to an engine block equipped with accessory mount portions.

### BACKGROUND

An engine block of a machine may be attached with accessories, such as an electrical accessory, an air compressor, gears, an aftertreatment system, a dual oil separator, and the like. Some of the above mentioned accessories may be driven by the crankshaft of the engine. The rotating power of the crankshaft may be transmitted via a belt, a pulley, gears and/or the like. For this reason, the accessories may be positioned and held onto the engine block. The engine block may have a plurality of holes at relevant positions to facilitate attachment of the accessories or the accessory mounting brackets. The accessories may be bolted onto the engine block through the mounting holes provided on the engine block. Also, heavy accessories may be held onto the engine block via accessory mounting brackets. The accessory mounting brackets may be placed at pre-determined positions on the engine block and held in place via bolts as is customary. However, there is often a need to adjust the accessories to operate properly. Also, the space considerations and requirements for proper calibration increase complexity. Furthermore, during operation the bolting engagements may be subjected to heavy loads and vibrations. In addition, repeated insertion and removal of the bolts for replacement or maintenance of the accessories may cause wear and tear of the threaded portions of the engine block causing these threaded portions to not fully thread with the bolts or become stripped and no longer functional. This may result in an inability to maintain the accessories at the pre-determined positions with consistency.

U.S. Pat. No. 8,511,272 discloses a cylinder block with a horizontal groove that extends horizontally to facilitate mounting of an electrical accessory bracket. The electrical accessory bracket is structured to allow mounting of an electrical accessory. However, the '272 reference does not include an efficient mechanism for attachment of the electrical accessory to the cylinder block.

### SUMMARY OF THE INVENTION

The present disclosure relates to an engine block for an internal combustion engine.

In accordance with the present disclosure, the engine block includes a first end and a second end. The first end includes a first periphery portion. The first end includes at least one conduit and a first attachment portion. The at least one conduit is disposed proximal to a camshaft mounting portion and adapted to carry a lubricant. The first attachment portion extends from the first periphery portion and is adapted to mount a gear assembly. Further, the second end includes a second periphery portion and includes a second attachment portion, a third attachment portion. The second attachment portion is located proximal to the second periphery portion and defines a mounting surface for an electrical accessory. The third attachment portion is structured and arranged to mount a speed sensor unit. The side is defined between the first end of the block and the second end of the block. The side includes a fourth attachment portion and at least one support pad. The fourth attachment portion is disposed proximal to the second end of the block and is structured to mount an oil separator. The at least one support pad is disposed proximal to the second end and is adapted to mount an engine aftertreatment system.

### BRIEF DESCRIPTION OF THE DRAWINGS

FIG. 1 is a perspective view of an engine block that shows a mounting surface for a gear assembly, in accordance with the concepts of the present disclosure;

FIG. 2 is a perspective view of the engine block attached to an oil separator, an engine aftertreatment system, and a speed sensor unit, in accordance with the concepts of the present disclosure;

FIG. 3 is a partial perspective view of an engine block showing a second end, in accordance with the concepts of the present disclosure; and

FIG. 4 is a partial perspective view of the engine block fitted with an electrical accessory, in accordance with the concepts of the present disclosure.

### DETAILED DESCRIPTION

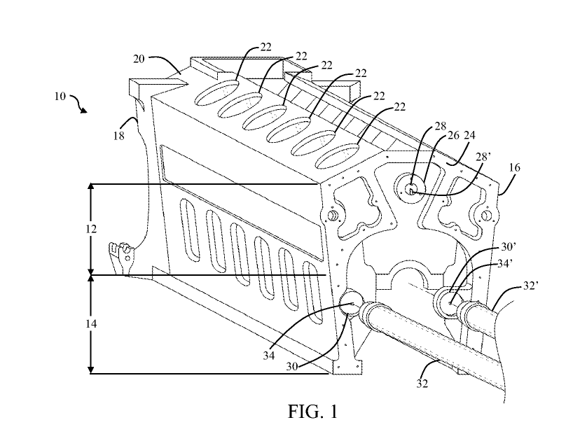

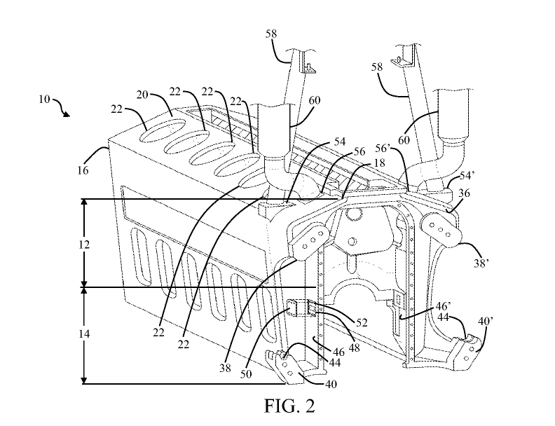

Referring to FIG. 1, there is shown an engine block 10. The engine block 10 may be made of cast iron, aluminum, or any other desirable material. The engine block 10 may be a single-piece casting and may generally include an upper section 12 and a lower section 14. In addition, the engine block 10 includes a first end 16 and a second end 18 (shown in FIG. 2). Between the first end 16 and the second end 18, a side 20 is defined.

The upper section 12 may include a plurality of cylinder bores 22, formed within the engine block 10. The cylinder bores 22 open through a side 20 of the engine block 10. Although six cylinder bores 22 are shown, it may be contemplated that the engine block 10 may include any number of cylinder bores 22, to receive pistons of an internal combustion engine (not shown).

The first end 16 is illustrated in FIG. 1. The second end 18 is shown in FIG. 2. The first end 16 is equipped with mounting provisions for various components. The first end 16 may include a camshaft mounting portion 26, two fluid conduits 28, and first attachment portions 30 and 30′. The camshaft mounting portion 26 is structured to allow a camshaft (not shown) to be attached to actuate the opening and closing of intake valves (not shown) and exhaust valves (not shown). Further, proximal to the camshaft mounting portion 26, the fluid conduits 28 are inserted in the upper section 12 of the engine block 10. The fluid conduits 28 are provided to supply clean oil to a main bearing (not shown) and the camshaft bearings (not shown). The first attachment portions 30 and 30′ are located in the lower section 14 of the first end 16. Particularly, the first attachment portions 30 and 30′ may be protrusions, which are arranged along the first end periphery 24 of the lower section 14. Two first attachment portions 30 and 30′ are shown in FIG. 1, that is, the first attachment portion 30 is positioned on left side of the first end 16 and the first attachment portion 30′ is positioned on right side of the first end 16. The first attachment portions 30 and 30′ act as mounting surfaces for a gear assembly 32 and 32′. The gear assembly 32 and 32′ are partially shown in a disassembled arrangement with the engine block 10. The gear assembly 32 and 32′, respectively, are attached to the first attachment portions 30 and 30′ by use of bolts (not shown) fastened to bolt holes 34 and 34′ present in each of the first attachment portions 30, 30′.

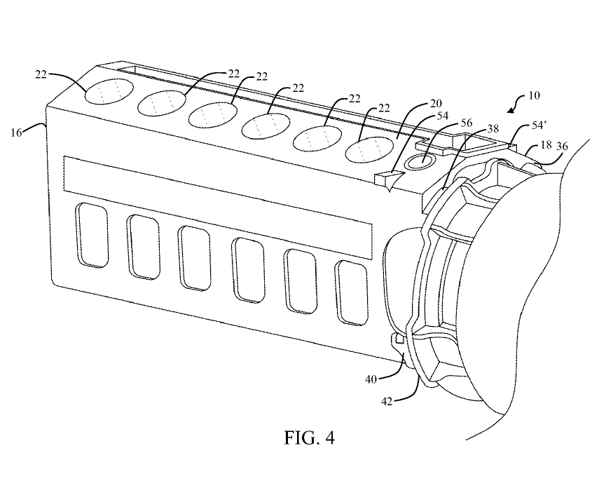

Referring to FIG. 2, there is shown the second side of the engine block 10. The second end 18 defines a second end periphery 36. The second end periphery 36 may protrude at corners of the second end 18, to form the second attachment portions 38 and 38′ in the upper section 12, and second attachment portions 40 and 40′ in the lower section 14. The second attachment portions 38, 38′, 40, and 40′ allow mounting of an electrical accessory 42 (shown in FIG. 4). The second attachment portions 38 and 38′ in the upper section 12 may be generally capsular in shape. Each of the second attachment portions 40 and 40′ include a set of grooves 44 at an end connected to the second end periphery 36. The set of grooves 44 are structured to facilitate rotation of the crankshaft (not shown) within the engine block 10, via a barring tool (not shown).

Further, the second end 18 may include two longitudinal members 46 and 46′, which extend along a height of the engine block 10. The longitudinal members 46 and 46′ are positioned parallel to each other. The longitudinal member 46 is shown with a third attachment portion 48. The third attachment portion 48 is shown with a disassembled speed sensor unit 50. The third attachment portion 48 may include holes 52. The holes 52 accommodate bolts (not shown) to attach the speed sensor unit 50 to third attachment portion 48.

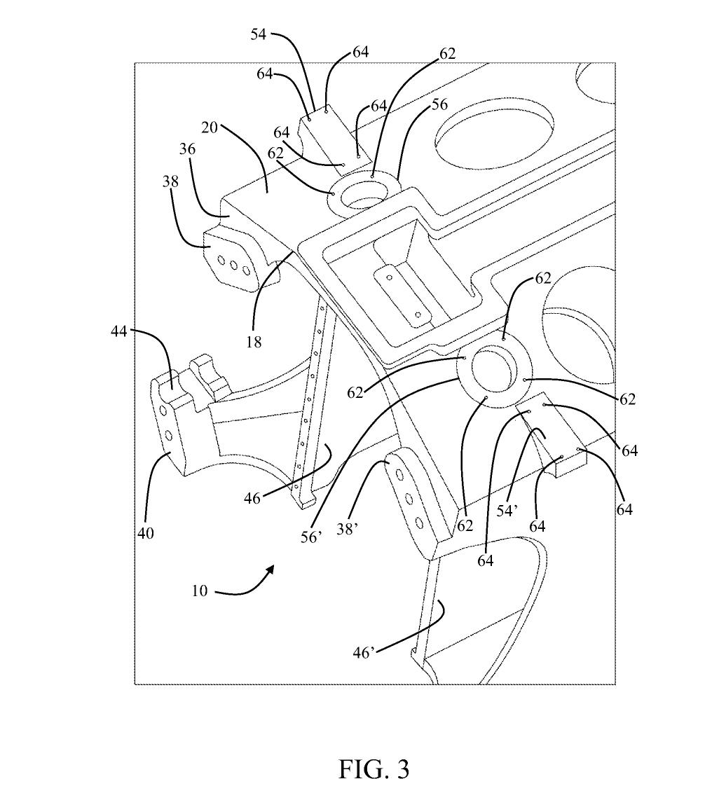

A portion of the side 20 of the engine block 10, proximal to the second end 18, includes support pads 54 and 54′ and fourth attachment portions 56 and 56′. The support pads 54 and 54′ acts as mounting surfaces for an engine aftertreatment system 58 (partially shown in FIG. 2). The fourth attachment portions 56 and 56′ are present proximal to the second end 18. The fourth attachment portions 56 and 56′ are mounting surfaces for an oil separator 60. As seen in FIG. 3, which shows a partial top view of the second end 18 of the engine block 10, the fourth attachment portions 56 and 56′ may be nearly circular in shape. The shape is to accommodate the oil separator 60. The fourth attachment portions 56 and 56′ may include holes 62. The holes 62 accommodate bolts (not shown) to fasten the oil separator 60 to the fourth attachment portions 56 and 56′. Further, the fourth attachment portions 56 and 56′ may be planar, rectangular portions structured to support the engine aftertreatment system 58. The support pads 54 and 54′ may also include holes 64. The holes 64 accommodate bolts (not shown) to attach the engine aftertreatment system 58 to the support pads 54 and 54′.

Referring to FIG. 4, there is shown a perspective view of the engine block 10 with the electrical accessory 42 fastened to the second end 18. Mounting portions of the electrical accessory 42 are attached to the second attachment portions 38, 38′, 40, and 40′ of the second end 18. The electrical accessory 42 is shown only partially in FIG. 4.

### INDUSTRIAL APPLICABILITY

In operation, the engine block 10 is equipped with various attachment portions to allow mounting of components like the electrical accessory 42, gear assembly 32, the engine aftertreatment system 58, the oil separator 60, and the fluid conduits 28. The engine block 10 is designed to have the first attachment portions 30 and two fluid conduits 28 at the first end 16 of the engine block 10. The first attachment portions 30 and 30′ are circular in shape and act as mounting surfaces for the gear assembly 32. The gear assembly 32 and 32′ may be fastened to the first attachment portions 30 and 30′ via bolts (not shown). The fluid conduits 28 are positioned proximal to the camshaft mounting portion 26. The fluid conduits 28 supply clean oil to the main bearing (not shown) and the camshaft bearings (not shown). Further, the second end 18 of the engine block 10 is equipped with the second attachment portions 38, 38′, 40, and 40′, the third attachment portion 48, the support pads 54 and 54′, and the fourth attachment portions 56 and 56′, to support the electrical accessory 42, the speed sensor unit 50, the engine aftertreatment system 58, and the oil separator 60, respectively.

The disclosed engine block 10 is equipped with the mounting surfaces to accommodate or support the components. Hence, this eliminates requirement of additional attachment brackets. Also, fastening of the components in an optimum position makes minimal use of bolts or other fastening means.

The many features and advantages of the disclosure are apparent from the detailed specification, and thus, it is intended by the appended claims to cover all such features and advantages of the disclosure, which fall within the true spirit and scope thereof. Further, since numerous modifications and variations will readily occur to those skilled in the art. It is not desired to limit the disclosure to the exact construction and operation illustrated and described, and, accordingly, all suitable modifications and equivalents may be resorted to that fall within the scope of the disclosure.

What is claimed is:

1. An engine block for an internal combustion engine, the engine block comprising:
a first end of the engine block defining a first periphery portion, the first end of the engine block including:
a first attachment portion extending from the first periphery portion, and adapted for mounting of a gear assembly;
a second end of the engine block defining a second periphery portion, the second end of the engine block including:
a second attachment portion being located proximal to the second periphery portion, wherein the second attachment portion defines a mounting surface for an electrical accessory; and
a third attachment portion structured and arranged for mounting a speed sensor unit; and
a side defined between the first end of the block and the second end of the block, the side including:
a fourth attachment portion disposed proximal to the first end of the block, the fourth attachment portion structured and arranged for mounting of an oil separator; and
at least one support pads disposed proximal to the first end, wherein the at least one support pad being adapted for mounting of an engine aftertreatment system.
